(19) United States
(12) Patent Application Publication
(10) Pub. No.: US 2008/0081700 A1
(43) Pub. Date: Apr. 3, 2008

(54) SYSTEM FOR PROVIDING AND PRESENTING FANTASY SPORTS DATA

(76) Inventors: BRYAN BINIAK, Los Angeles, CA (US); Chris Cunningham, Los Angeles, CA (US); Atanas Ivanov, Santa Monica, CA (US); Jeffrey Marks, Sherman Oaks, CA (US); Brock Meltzer, Los Angeles, CA (US)

Correspondence Address: DLA PIPER US LLP, 1999 AVENUE OF THE STARS, SUITE 400, LOS ANGELES, CA, 90067-6023, US

(21) Appl. No.: 11/848,182

(22) Filed: Aug. 30, 2007

Related U.S. Application Data
(63) Continuation-in-part of application No. 11/540,748, filed on Sep. 29, 2006.

(51) Int. Cl. A63F 13/12

(52) U.S. Cl. 463/42

(57) ABSTRACT

The system provides a method to present a Fantasy League and Fantasy Games in a fully customizable format. The system provides a match up experience where the owner can focus on his own team as if it were a single game with all of the owner's players participating (even though the owner's players come from different teams and play at different times and even different days of the week). The system also provides for match up presentation for Head-to-Head leagues so it appears as if a real game between two Fantasy Teams is being played. The system includes a scoreboard, play by play, player profiles, boxscores, images and video, news, chat, contextual information, alerts, and other information related to the owner's team.

### RELATED APPLICATIONS

This is a continuation-in-part of, and claims priority to, pending U.S. patent application Ser. No. 11/540,748 filed Sep. 29, 2006 and entitled “Social Media Platform and Method” which is incorporated in its entirety herein.

### FIELD OF THE INVENTION

The invention relates generally to a system and method for providing a computer presentation associated with a broadcast.

### BACKGROUND OF THE INVENTION

The television broadcast experience has not changed dramatically since its introduction in the early 1900s. In particular, live and prerecorded video is transmitted to a device, such as a television, liquid crystal display device, computer monitor and the like, while viewers passively engage.

With broadband Internet adoption and mobile data services hitting critical mass, television is at a cross roads faced with:
Declining Viewership
Degraded Ad Recognition
Declining Ad Rates & Spend
Audience Sprawl
Diversionary Channel Surfing
Imprecise and Impersonal Audience Measurement Tools
Absence of Response Mechanism
Increased Production Costs

In addition, there is a tremendous increase in the number of people that have high speed (cable model, DSL, broadband, etc.) access to the internet so that it is easier for people to download content from the internet. There has also been a trend in which people are accessing the Internet while watching television. Thus, it is desirable to provide a parallel programming experience that is a reinvograted version of the current television broadcast experience that incorporates new Internet based content.

One environment where parallel programming has enjoyed interest is in the arena of so called “fantasy sports”. Fantasy sports is a game where fantasy team owners construct a team and compete against other fantasy owners based on the statistics of the players on their team. Typically a fantasy team is limited to a single sport (e.g. pro football, pro basketball, pro baseball, etc.) and the players can be from any team in that league. The following are descriptions of some of the terms that will be used herein related to fantasy sports.

Fantasy Sports A fantasy sport is a game where fantasy owners build a team that competes against other fantasy owners based on the statistics generated by individual players or teams of a professional sport.

Fantasy Team A Fantasy team is made up of real players from a professional sport. A Fantasy team has both active and bench players that the Fantasy Owner manages. The statistics of “active” players count toward a Fantasy Owner's total Fantasy points for a defined period (for example, a week). The number of players allowed on a team is defined by the roster rules determined by the commissioner.

Roster The roster is made up of individual players. This includes starters (active) players (players whose performance counts toward the Fantasy Owner's fantasy score) and bench players (players whose performance does not count toward the Fantasy Owner's fantasy score).

Free Agents Free agents are players that are not part of a team roster and are available to be added to a team roster by a Fantasy Owner. The number of players on the Fantasy Teams is typically less than the number of actual players in a real professional league. This means that there are always a number of free agents available to be added to a Roster in place of a current Fantasy Team member.

Fantasy League A Fantasy league is made up of teams. Fantasy leagues within the same Fantasy Site can all have different scoring and roster rules as defined by the League Commissioner. Often a Fantasy League is made up of ten owners although other configurations are possible.

Fantasy Site Websites that run fantasy leagues. Examples include Yahoo, ESPN, CBSsportsline. In the early days of Fantasy Sports, the management of the league and the maintenance of statistics was done manually. Since the advent of the internet, Fantasy Sites have taken over the administrative aspects of Fantasy League management.

Fantasy Owners/Managers Fantasy Owners manage the fantasy team including drafting, adding, and dropping individual players.

Commissioner The Commissioner signs up for a Fantasy League on a Fantasy Site and is responsible for inviting fantasy owners and setting up league scoring and roster rules. The commissioner is also a Fantasy Owner.

Fantasy points Fantasy points are calculated based on statistics generated by individual players on a fantasy owner's roster and scoring rules setup for that league by the commissioner. The scoring can vary from league to league and from sport to sport. Typically a Fantasy League will have a charter defining the scoring rules of the league, the rules on trading of players (often the Commissioner must approve a trade) and other rules associated with the league.

Head-to-Head League This is a league setting setup by the commissioner. In a Head-to-Head League, teams compete in a weekly matchup against another manager's team to see who can compile the best stats across a number of different categories as defined by the commissioner. Each week, all of the Fantasy Teams are paired up in head to head competition. The team that has the most points for that week vis-à-vis its opponent is considered to have “won” the game that week. The team with the most wins is the champion. In other leagues, the scoring is a cumulative affair where the team that compiles the most points over the season is the winner. In a Head-to-Head League, the winner will not necessarily have the most points.

Current systems for operating a Fantasy League have a number of disadvantages. One disadvantage is the fact that the league presentations are not customizable. If they are hosted by a site the leagues have a fixed format that cannot be changed. Current systems are limited to scoring and do not provide additional information about players and other data that could be important to the Fantasy Owner. In addition, in Head-to-Head leagues, the current system does not provide for a game-like environment between Fantasy Teams. In some cases, additional data is available on existing fantasy sites, but for added cost. This is not necessarily tied to a “game experience, but more generally related to the fantasy roster.

### SUMMARY

The system provides a method to present a Fantasy League and Fantasy Games in a fully customizable format. The system provides a match up experience where the owner can focus on his own team as if it were a single game with all of the owner's players participating (even though the owner's players come from different teams and play at different times and even different days of the week). The system also provides for match up presentation for Head-to-Head leagues so it appears as if a real game between two Fantasy Teams is being played. The system includes a scoreboard for the user's match-up that shows the names of the Fantasy Teams playing as well as additional scoreboards showing the match-ups of other Fantasy Teams in the Fantasy League. In addition to the scoreboard, the system provides play by play, player profiles, boxscores, images and video, news, chat, contextual information, alerts, and other information related to the owner's team.

### BRIEF DESCRIPTION OF THE DRAWINGS

FIG. 1 illustrates the high level flow of information and content through the Social Media Platform;

FIG. 2 illustrates the content flow and the creation of generative media via a Social Media Platform;

FIG. 3 illustrates the detailed platform architecture components of the Social Media Platform for creation of generative media and parallel programming shown in FIG. 2; and

FIGS. 4-6 illustrate an example of the user interface for an implementation of the Social Media Platform and the Parallel Programming experience.

FIG. 7 is a block diagram illustrating an embodiment of the system.

FIG. 8 is a flow diagram illustrating the operation of an embodiment of the system.

### DETAILED DESCRIPTION

A system for presenting customizable information about fantasy sports teams is described. In the following description, numerous specific details are set forth to provide a more thorough description of the system. It will be apparent, however, that the system may be practiced without these specific details. In other instances, well know features have not been described in detail.

Social Media Platform

In one embodiment, the invention is particularly applicable to a Social Media Platform in which the source of the original content is a broadcast television signal and it is in this context that the invention will be described. It will be appreciated, however, that the system and method has greater utility since it can be used with a plurality of different types of original source content.

The ecosystem of the Social Media Platform may include primary sources of media, generative media, participatory media, generative programming, parallel programming, and accessory devices. The Social Media Platform uses the different sources of original content to create generative media, which is made available through generative programming and parallel programming (when published in parallel with the primary source of original content). The generative media may be any media connected to a network that is generated based on the media coming from the primary sources. The generative programming is the way the generative media is exposed for consumption by an internal or external system. The parallel programming is achieved when the generative programming is contextually synchronized and published in parallel with the transmitted media (source of original content). The participatory media means that third parties can produce generative media, which can be contextually linked and tuned with the transmitted media. The accessory devices of the Social Media Platform and the parallel programming experience may include desktop or laptop PCs, mobile phones, PDAs, wireless email devices, handheld gaming units and/or PocketPCs that are the new remote controls.

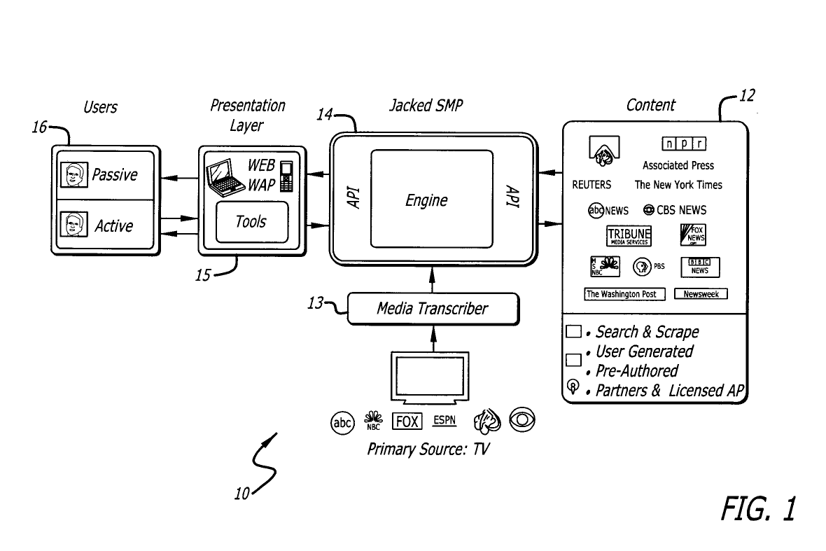

FIG. 1 illustrates the high level flow of information and content through the Social Media Platform 8. The platform may include an original content source 10, such as a television broadcast, with a contextual secondary content source 12, that contains different content wherein the content from the original content source is synchronized with the content from the contextual content source so that the user views the original content source while being provided with the additional content contextually relevant to the original content in real time.

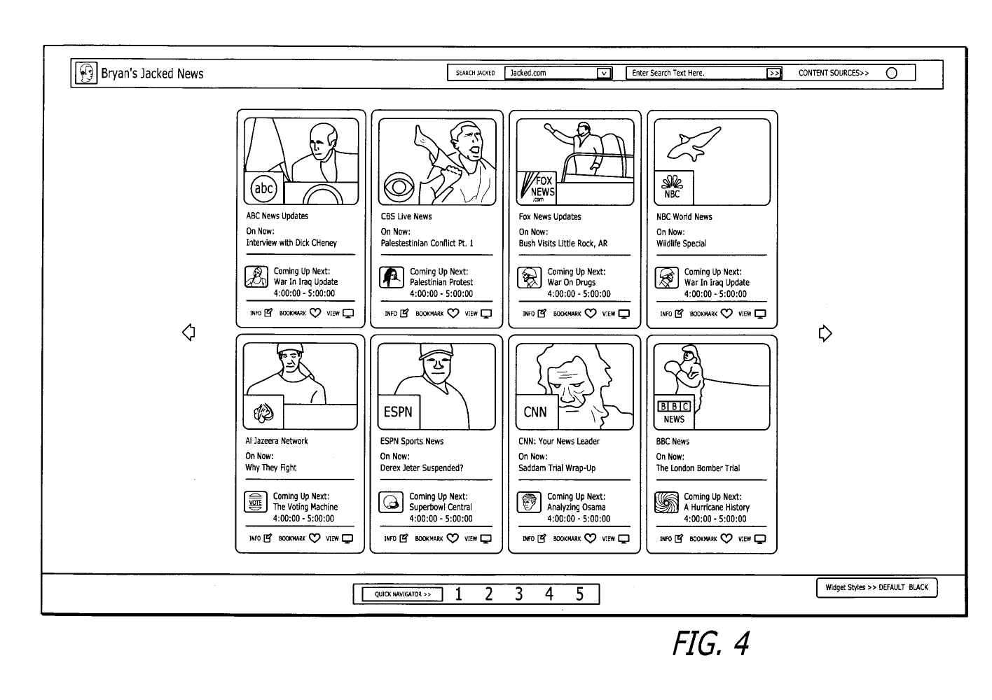

The contextual content source 12 may include different types of contextual media including text, images, audio, video, advertising, commerce (purchasing) as well as third party content such as publisher content (such as Time, Inc., XML), web content, consumer content, advertiser content and retail content. An example of an embodiment of the user interface of the contextual content source is described below with reference to FIGS. 4-6. The contextual content source 12 may be generated/provided using various techniques such as search and scrape, user generated, pre-authored and partner and licensed material.

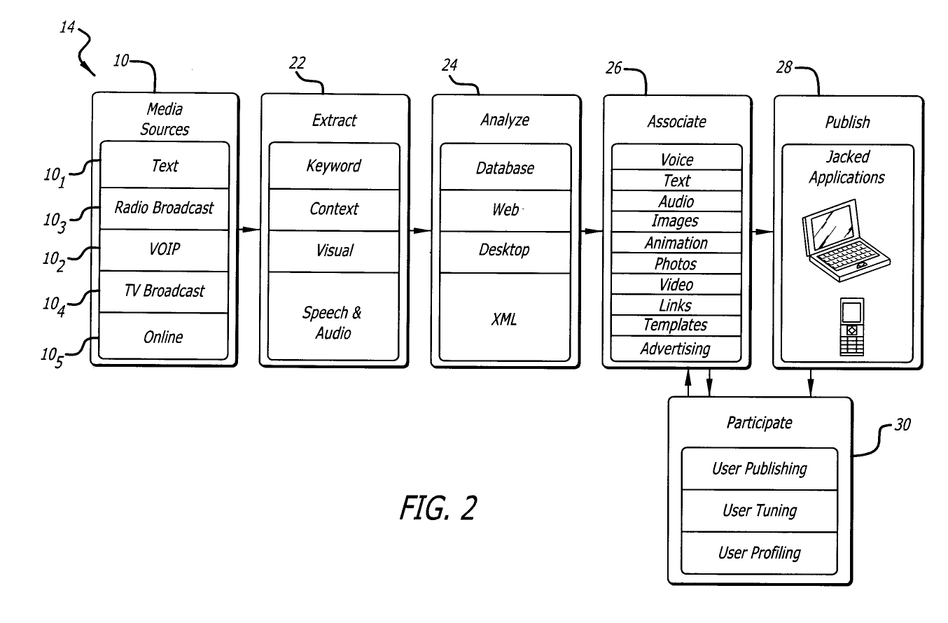

The original/primary content source 10 is fed into a media transcriber 13 that extracts information from the original content source which is fed into a social media platform 14 that contains an engine and an API for the contextual content and the users. The Social Media Platform 14 at that point extracts, analyzes, and associates the Generative Media (shown in more detail in FIG. 2) with content from various sources. Contextually relevant content is then published via a presentation layer 15 to end users 16 wherein the end users may be passive and/or active users. The passive users will view the original content in synchronization with the contextual content while the active users will use tools made accessible to the user to tune content, create and publish widgets, and create and publish dashboards. The users may use one device to view both the original content and the contextual content (such as television in one embodiment) or use different devices to view the original content and the contextual content (such as on a web page as shown in the examples below of the user interface).

The social media platform uses linear broadcast programming (the original content) to generate participative, parallel programming (the contextual/secondary content) wherein the original content and secondary content may be synchronized and delivered to the user. The social media platform enables viewers to jack-in into broadcasts to tune and publish their own content. The social media platform also extends the reach of advertising and integrates communication, community and commerce together.

FIG. 2 illustrates content flow and creation of generative media via a Social Media Platform 14. The system 14 accesses the original content source 10 and the contextual/secondary content source 12 shown in FIG. 1. As shown in FIG. 2, the original content source 10 may include, but is not limited to, a text source 10₁, such as Instant Messaging (IM), SMS, a blog or an email, a voice over IP source 10₂, a radio broadcast source 10₃, a television broadcast source 10₄ or a online broadcast source 10₅, such as a streamed broadcast. Other types of original content sources may also be used (even those yet to be developed original content sources) and those other original content sources are within the scope of the invention since the invention can be used with any original content source as will be understood by one of ordinary skill in the art. The original content may be transmitted to a user over various medium, such as over a cable, and displayed on various devices, such as a television attached to the cable, since the system is not limited to any particular transmission medium or display device for the original content. The secondary source 12 may be used to create contextually relevant generative content that is transmitted to and displayed on a device 28 wherein the device may be any processing unit based device with sufficient processing power, memory and connectivity to receive the contextual content. For example, the device 28 may be a personal computer or a mobile phone (as shown in FIG. 2), but the device may also be PDAs, laptops, wireless email devices, handheld gaming units and/or PocketPCs. The invention is also not limited to any particular device on which the contextual content is displayed.

The social media platform 14, in this embodiment, may be a computer implemented system that has one or more units (on the same computer resources such as servers or spread across a plurality of computer resources) that provide the functionality of the system wherein each unit may have a plurality of lines of computer code executed by the computer resource on which the unit is located that implement the processes and steps and functions described below in more detail. The social media platform 14 may capture data from the original content source and analyze the captured data to determine the context/subject matter of the original content, associate the data with one or more pieces of contextual data that is relevant to the original content based on the determined context/subject matter of the original content and provide the one or more pieces of contextual data to the user synchronized with the original content. The social media platform 14 may include an extract unit 22 that performs extraction functions and steps, an analyze unit 24 that performs an analysis of the extracted data from the original source, an associate unit 26 that associates contextual content with the original content based on the analysis, a publishing unit 28 that publishes the contextual content in synchronism with the original content and a participatory unit 30.

The extraction unit 22 captures the digital data from the original content source 10 and extracts or determines information about the original content based on an analysis of the original content. The analysis may occur through keyword analysis, context analysis, visual analysis and speech/audio recognition analysis. For example, the digital data from the original content may include close captioning information or metadata associated with the original content that can be analyzed for keywords and context to determine the subject matter of the original content. As another example, the image information in the original content can be analyzed by a computer, such as by video optical character recognition to text conversion, to generate information about the subject matter of the original content. Similarly, the audio portion of the original content can be converted using speech/audio recognition to obtain textual representation of the audio. The extracted closed captioning and other textual data is fed to an analysis component which is responsible for extracting the topic and the meaning of the context. The extract unit 22 may also include a mechanism to address an absence or lack of close caption data in the original content and/or a mechanism for addressing too much data that may be known as “informational noise.”

Once the keywords/subject matter/context of the original content is determined, that information is fed into the analyze unit 24 which may include a contextual search unit. The analysis unit 24 may perform one or more searches, such as database searches, web searches, desktop searches and/or XML searches, to identify contextual content in real time that is relevant to the particular subject matter of the original content at the particular time. The resultant contextual content, also called generative media, is then fed into the association unit 26 which generates the real-time contextual data for the original content at that particular time. As shown in FIG. 2, the contextual data may include, for example, voice data, text data, audio data, image data, animation data, photos, video data, links and hyperlinks, templates and/or advertising.

The participatory unit 30 may be used to add other third party/user contextual data into the association unit 26. The participatory contextual data may include user publishing information (information/content generated by the user or a third party), user tuning (permitting the user to tune the contextual data sent to the user) and user profiling (that permits the user to create a profile that will affect the contextual data sent to the user). An example of the user publishing information may be a voiceover of the user which is then played over the muted original content. For example, a user who is a baseball fan might do the play-by-play for a game and then play his play-by-play while the game is being played wherein the audio of the original announcer is muted which may be known as fan casting.

The publishing unit 28 may receive data from the association unit 26 and interact with the participatory unit 30. The publishing unit 28 may publish the contextual data into one or more formats that may include, for example, a proprietary application format, a PC format (including for example a website, a widget, a toolbar, an IM plug-in or a media player plug-in) or a mobile device format (including for example WAP format, JAVA format or the BREW format). The formatted contextual data is then provided, in real time and in synchronization with the original content, to the devices 16 that display the contextual content.

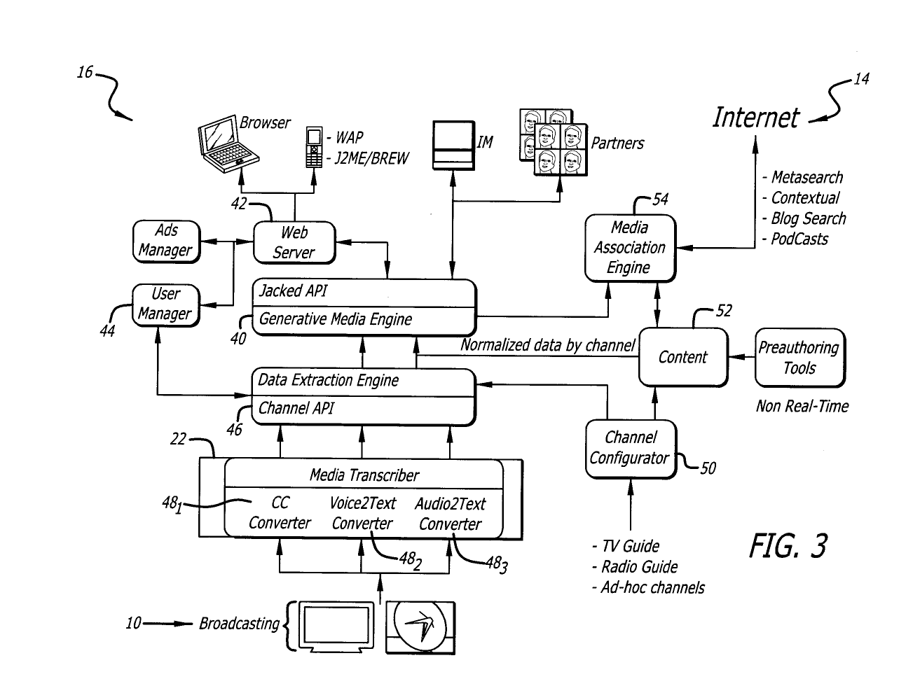

FIG. 3 illustrates more details of the Social Media Platform for creation of generative media and parallel programming shown in FIG. 2 with the original content source 10, the devices 16 and the social media platform 14. The platform may further include a Generative Media engine 40 (that contains a portion of the extract unit 22, the analysis unit 24, the associate unit 26, the publishing unit 28 and the participatory unit 30 shown in FIG. 2) that includes an API wherein the IM users and partners can communicate with the engine 40 through the API. The devices 16 communicate with the API through a well known web server 42. A user manager unit 44 is coupled to the web server to store user data information and tune the contextual content being delivered to each user through the web server 42. The platform 14 may further include a data processing engine 46 that generates normalized data by channel (the channels are the different types of the original content) and the data is fed into the engine 40 that generates the contextual content and delivers it to the users. The data processing engine 46 has an API that receives data from a close captioning converter unit 48₁ (that analyzes the close captioning of the original content), a voice to text converter unit 48₂ (that converts the voice of the original content into text) so that the contextual search can be performed and an audio to text converter unit 48₃ (that converts the voice of the original content into text) so that the contextual search can be performed wherein each of these units is part of the extract unit 22. The close captioning converter unit 48₁ may also perform filtering of “dirty” close captioning data such as close captioning data with misspellings, missing words, out of order words, grammatical issues, punctuation issues and the like.

The data processing engine 46 also receives input from a channel configurator 50 that configures the content for each different type of content. The data from the original content and the data processed by the data processing engine 46 are stored in a data storage unit 52 that may be a database. The database also stores the channel configuration information, content from the preauthoring tools (which is not in realtime) and search results from a search coordination engine 54 used for the contextual content. The search coordination engine 54 (part of the analysis unit 24 in FIG. 2) coordinates the one or more searches used to identify the contextual content wherein the searches may include a metasearch, a contextual search, a blog search and a podcast search.

FIGS. 4-6 illustrate an example of the user interface for an implementation of the Social Media Platform. For example, when a user goes to the system, the user interface shown in FIG. 4 may be displayed. In this user interface, a plurality of channels (such as Fox News, BBC News, CNN Breaking News) are shown wherein each channel displays content from the particular channel. It should be noted, that each of the channels may also be associated with one or more templates to present the secondary source data to the user. The templates may be automatically selected based on the broadcast on that channel, or may be manually selected by the user.

Although the interface of FIG. 4 is illustrated as a plurality of available channels such as is consistent with the operation of a television, it should be understood that the interface can be configured by event or even type of event. For example, one tile could represent football with drill down possibilities to college or pro football, and drill down to all available games in each sport.

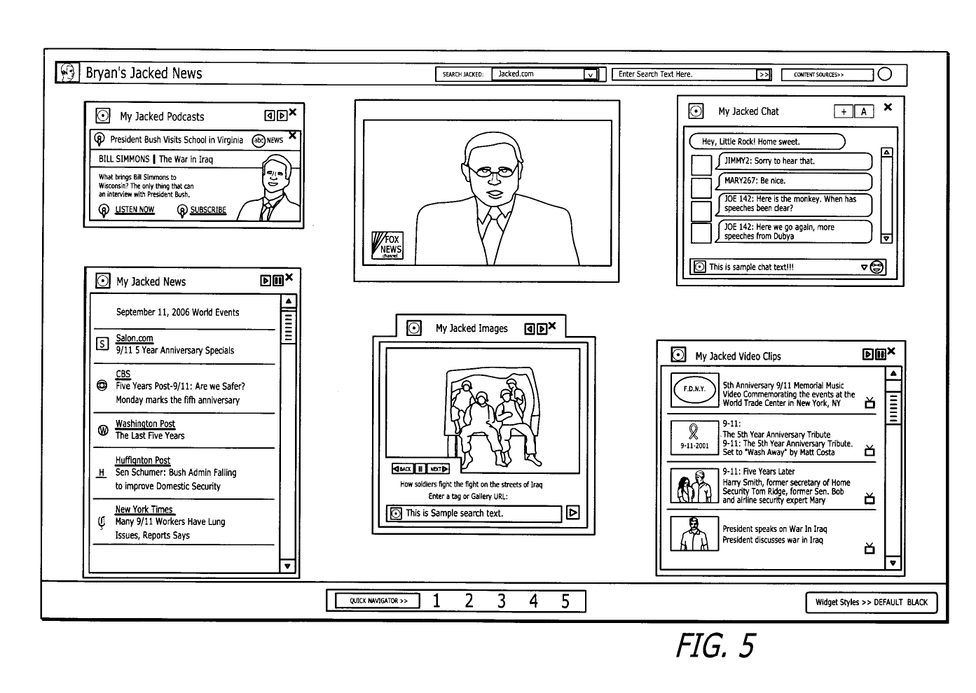

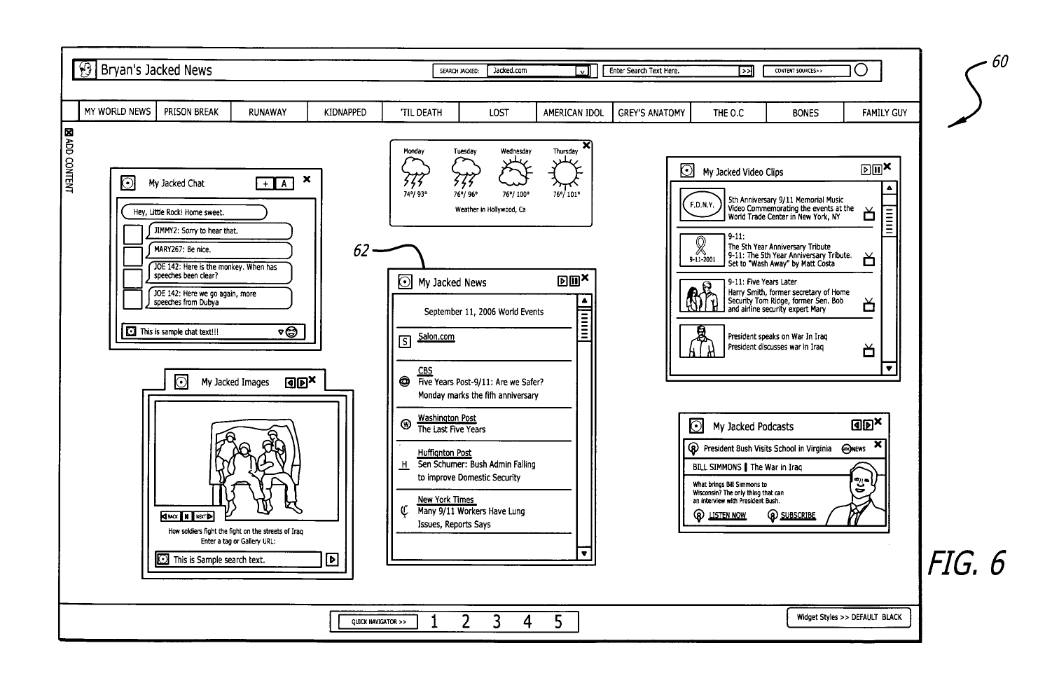

When a user selects the Fox News channel, the user interface shown in FIG. 5 is displayed to the user which has the Fox News content (the original content) in a window along with one or more contextual windows that display the contextual data that is related to what is being shown in the original content. In this example, the contextual data may include image slideshows, instant messaging content, RSS text feeds, podcasts/audio and video content. The contextual data shown in FIG. 5 is generated in real-time by the Generative Media engine 40 based on the original content capture and analysis so that the contextual data is synchronized with the original content. FIG. 6 shows an example of the webpage 60 with a plurality of widgets (such as a “My Jacked News” widget 62, “My Jacked Images” widget, etc.) wherein each widget displays contextual data about a particular topic without the original content source being shown on the same webpage.

Fantasy Sports Presentation

The social media platform described above can be adapted to be used in connection with the fantasy sports presentation of the system. The system uses a number of widgets for presentation to the user. A non-exhaustive example of widgets used in an embodiment of the system include scoreboard, the system provides play by play, player profiles, boxscores, images and video, news, chat, contextual information, alerts, and other information related to the owner's team.

The scoreboard is a widget that displays opponents and related game information. The scoreboard for the user's match-up that shows the names of the Fantasy Teams playing. Another scoreboard (other game scoreboard) shows the match-ups of other Fantasy Teams in the Fantasy League. The play by play widget will show plays that mention a player on a user's fantasy roster and/or opponents roster (the user can customize the play by play to limit it to his own team if desired). The player profile widget will show profile and personal information for players on the user's fantasy roster and/or opponents roster. The Boxscore widget shows player statistics for players on the user's fantasy roster and/or player statistics for the user's opponent. A photo widget shows photos and images filtered based on the user's fantasy roster and/or opponent's roster. A news widget displays relevant news and may be filtered based on the user's fantasy roster and/or opponents roster. A chat widget is targeted to the participants in the league. Contextual information is used to display other information and may be displayed for the user's fantasy roster and/or opponents roster for any additional widgets supported for that sport. An alert widget is used to detect, display, and forward alerts based on alert requests set by the user. For example, an owner may want an alert sent to him whenever one of his players is mentioned in the news. This can be important in managing the Fantasy Team. If a player becomes injured or it is determined that the player will not play, it is important for the owner to find out immediately so that corrective roster action can be taken. Similarly, if a player is slated to play who hadn't been playing, the owner will want to know of that option. An owner may also want to set alerts for opposing team members as well. Sometimes there are steps that can be taken to limit the ability of an opposing owner to react favorably to a change in player status and time is of the essence in such a case. The alert widget allows the owner to be made instantly aware of important information.

Block Diagram

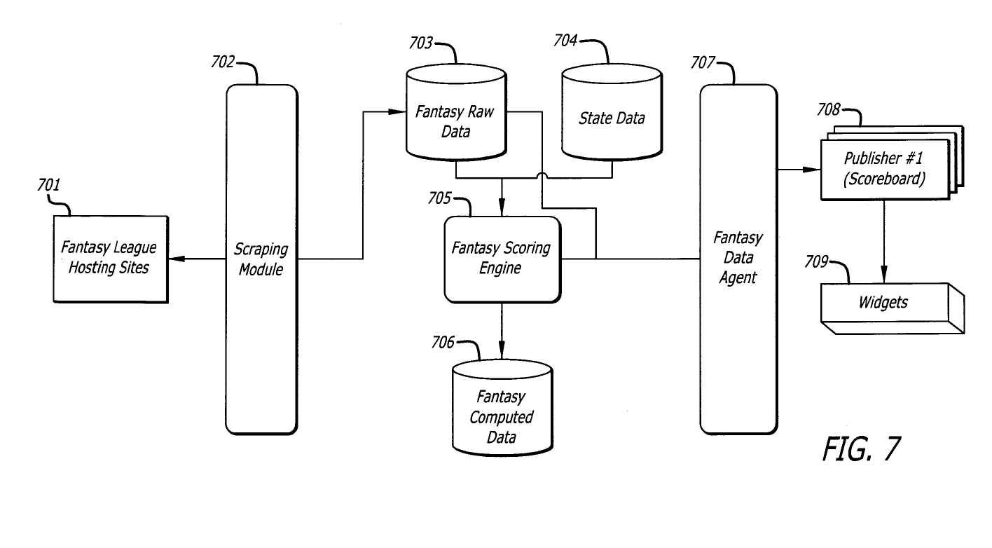

FIG. 7 is block diagram illustrating an embodiment of the system. Fantasy League hosting sites 701 (such as YahooSports, ESPN, and CBSSports, and others) are coupled to a scraping module 702. The sites mentioned are exemplary only and others may be incorporated into the system. The sites are typically connected to the scraping module 702 via the internet.

The scraping module 702 is coupled to a database 703 that stores the raw fantasy data for the leagues that subscribe to the system. Database 704 stores statistical information related to the league. The databases are coupled fantasy scoring engine 705 which is in turn coupled to database 706 for storing computed fantasy data. It should be noted that although the databases are shown as separate elements, they may be stored in a single database as desired. The fantasy raw data database 703 and fantasy scoring engine 705 are coupled to fantasy data agent 707. The fantasy data agent 707 is coupled to the scoreboard 708 and widgets 709.

### Scraping Module

The scraping module 702 is designed to retrieve Fantasy League data from the sites that are servicing the Fantasy Teams. The scraping module must be able to impersonate an authorized user so that league, team, roster, and rules can be retrieved from the hosting site. In one embodiment, Fantasy League owners can sign up with a hosting site. Once the Fantasy League and Fantasy Teams are formed, the Fantasy Owners register their teams on the system, including user names and passwords used for the hosting site. The owners then use the system to follow league play instead of the hosting site. The system scrapes data from the hosting site periodically and provides required information (e.g. trades, deactivation of players, roster selections, etc.) back to the hosting site as needed for compliance. The owners can do all league operations on the system which then forwards the information to the hosting site.

The scraping module 702 should be able to handle html and xml elements, AJAX controls, and be able to obtain data from the following pages on a host site:
Fantasy Managers—page is scraped to store all team names in a league and email addresses for each team name. Registered system users who have provided valid fantasy credentials to the system will get the option to send an email to other users in the Fantasy league to inform them about the system.
Fantasy Rules—page is scraped to store scoring type and stat categories.
Fantasy Rosters—page is scraped for each team to store player roster.
Fantasy Matchups—page is scraped to store matchups for each week.

Examples of scraping software that could be used for the system includes Screen-Scraper, Dapper, and Statfink. It should be noted that not all Fantasy Owners need to subscribe to the system. Any Fantasy Owner can subscribe to the system individually as desired.

Fantasy Scoring Engine

The fantasy scoring engine 705 is the module that computes the scores of the Fantasy Team using the rules that have been setup by the Commissioner on a fantasy site in connection with a statistical data source (e.g. Stats, Inc. or Stats Live). The scoring engine can support multiple sports (e.g. football, basketball, baseball) and should be able to handle the different scoring rules promulgated by different Fantasy Leagues. The scoring could be in real time (during actual game play) or updated at the end of each day a game is played.

Fantasy Data Agent

The fantasy data agent 707 is used to aggregate data and send data to the appropriate users depending on the customization selections that the users have made and the Fantasy Team rosters. The fantasy data agent is also in charge of sending out alerts as appropriate based on the users requests for alerts.

Sign-in and Access

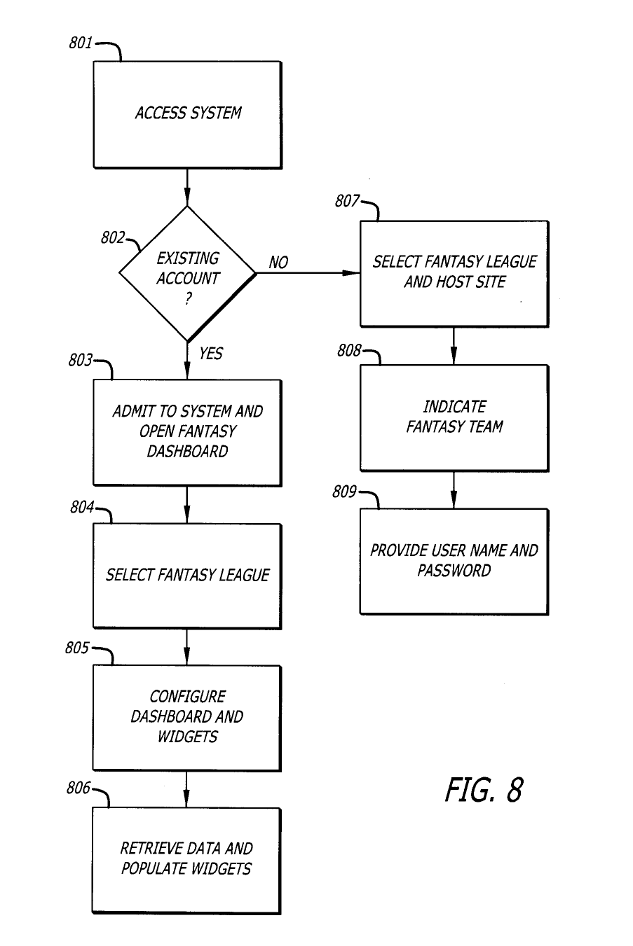

FIG. 8 is a flow diagram illustrating the sign-in/access process for a Fantasy Owner. As note above, the system provides all the information and management capability for enjoying a Fantasy League that is hosted on a third party site, but with heretofore unavailable customization and features. At step 801 the user visits the system, typically via a web browser. At decision block 802 it is determined if the user is a new user or a returning user. If the user is a returning user, the system proceeds to step 803 and is admitted into the system to open a fantasy dashboard presentation in their browser. At step 804 the user selects the particular Fantasy League of which he is a member and then clicks on a scheduled Fantasy League game. At step 805 the dashboard is configured with the customized widgets that the user has selected for the customized fantasy dashboard. At step 806 the system begins retrieving data and updating the widgets as appropriate. At this point the user can leave the dashboard open for as long as desired and follow his Fantasy Team until the scoring period is over. If it is a Head-to-Head match, the presentation can include a running score for the owner and the owners opponent. In professional football, the scoring period is typically all day Sunday till the end of the Monday Night Football game. At the end of the last game for the scoring period, the owner is presented with the results of the game.

If the owner is a new sign-in at decision block 802, the system proceeds to step 807. At step 807 the owner selects the Fantasy League of which he is a member, and its host site, and indicates his Fantasy Team at step 808. The owner indicates his username and password for his Fantasy League at step 809. The system can then scrape the host site for the owners roster data, league rules, and other data and set up the owner in the databases of the system. The owner then has the option of proceeding to the dashboard of step 803 or exiting the system till another time.

Widgets

The system provides a unique and customizable user experience that is not available via current hosting sites. This is possible in part because the system provides a plurality of widgets that are available for use. In one embodiment, the user can design and use custom widgets as well. A widget is a presentation module that presents secondary content to the user. The presentation of the content may be based on triggers or it may be independent of triggers. In some cases the presentation of content is time dependent. In other cases the presentation of content is generated by third parties and is related only to the generation of new content by those third parties. In one embodiment, the user can have a plurality of widgets on a computer display, with each widget providing a particular type of content. The system allows the user to select from a plurality of widgets and to arrange them on a display desktop as desired. FIG. 6 is an example of a number of widgets that are arranged on the user's desktop.

Widgets in the fantasy dashboard display content specific to the Fantasy Owner, his team, and roster, and optionally, the owner's opponent. The system contemplates a plurality of predefined widgets in one embodiment.

News/Ticker

The news ticker widget is a widget that scans news sites and retrieves stories based on keywords. Consider the case where Fantasy team 1 has a Fantasy matchup with Fantasy team 2. News may be filtered by “Player Name” based on roster of Fantasy team 1 and Fantasy team 2. The News and Ticker widget will display news stories only for players on Fantasy team 1 and Fantasy team 2. Keywords used for the News and Ticker widget would be “Player name” for players on Fantasy team 1 and Fantasy team 2. There could also be multiple instances of the widgets in a nested arrangement. For example, there could be an instance of News/Ticker filtered by “Fantasy team 1”, filtered by “Fantasy team 2”, or filtered by “matchup” (includes “Fantasy team 1” and “Fantasy team 2”). Additionally, stats tickers can be created that display only pure statistical data for both or either fantasy team, free agents or individuals on either roster.

Photos

The photo widget finds and displays photos based on keywords such as player name, team name, etc. Consider Fantasy team 1 in a Fantasy matchup with Fantasy team 2. Photos will be filtered by “Player Name” based on roster of Fantasy team 1 and Fantasy team 2. The In-game photos widget will display in-game photos only for players on Fantasy team 1 and Fantasy team 2 in one embodiment. Keywords used for the photos widget would be “Player name” for players on Fantasy team 1 and Fantasy team 2. The photo widget may also be nested and may display photos based on any suitable metadata and keywords.

Scoreboard

As noted above, the scoreboard widget can show either a single teams accumulation of points or it can show the head to head point accumulation of a team and its opponent (i.e. Fantasy team 1 has a Fantasy matchup with Fantasy team 2. Fantasy points for each team will be calculated based on “Active” Players on Fantasy team 1 and Fantasy team 2, which data is scraped from the host site. Instead of a scoreboard with actual NFL opposing teams such as “Denver Broncos vs. San Diego Chargers” the scoreboard widget will show the Fantasy team 1 name and the Fantasy team 2 name. This ability to give the impression that the two Fantasy teams are actually playing each other distinguishes the present system from the current art.

Fantasy team 1 and Fantasy team 2 score will be calculated based on player's statistics received from a statistical database, such as, for example, Stats Inc. Only statistics of “Active” players get calculated for the Fantasy score.

Scoreboard of Other Games Where Fantasy team 1 has a Fantasy match-up with Fantasy team 2. Fantasy points for each team will be calculated based on “Active” Players on Fantasy team 1 and Fantasy team 2. The scoreboard of other games in the Fantasy League will show all fantasy matchups for a specific league. It will display as a tab in the scoreboard of other games like other sports (NFL, NBA, etc.).

Play by Play

The play by play widget will give updates of activities of the active roster of the owners Fantasy team during a match or scoring period. Where Fantasy team 1 has a Fantasy matchup with Fantasy team 2, Play by Play will be filtered by “Player Name” based on the roster of Fantasy team 1 and Fantasy team 2. In one embodiment, the play by play widget will only show plays that mention a player on a Fantasy team 1 roster and Fantasy team 2 roster

Player Profile

The Player Profile widget will only display players on a Fantasy team 1 roster and Fantasy team 2 roster. Players being displayed will be keyed off of the Stats Inc. Play by Play. The Player Profile widget may display personal information about the player including current game statistics, season statistics and other relevant data.

Boxscore

The Boxscore widget displays the roster members starting at beginning of game, number of fantasy players that have played, and current fantasy points. The fantasy points are calculated based on the Fantasy League rules scraped from the host site.

Chat

The chat widget is to enable live chat between owners. In one embodiment, only registered system users that are in the same fantasy league are available to chat in that chat room. The system should be able to identify and associate users in the same Fantasy league. Only users that are in the same Fantasy league will be able to chat on the Fantasy tab. The chat widget can display the owner's name, the owner's Fantasy Team name, or some other name selected by the owner.

Using presence, the system will visually notify or alert the user if another user in the same Fantasy league is on the system site so that they can be invited to chat in the chat room. Accepting the invitation will open up the user's fantasy tab with the chat widget open.

Player Tracker

The player tracker widget tracks news, statistics, and other related information of a player on the owner's watch list. If the Player Profile widget is not on the user's Fantasy tab, the user opens the widget gallery and adds the Player Profile widget to their Fantasy tab. The user can add a player to their “watch” list. Player displays in the user's Player Profile widget with all other player's from their fantasy roster.

Player Compare (Player Profile Widget Enhancement)

An owner accesses the system and selects the player profile widget to access the player compare feature. The owner will be able to manually select Fantasy Players to compare to each other. The comparison can be on a daily, season, and career statistics including fantasy points that the player has earned or could have earned if designated as a starter.

In addition to comparing players selected by an owner, the system can seek out comparable players based on selected metrics such as actual statistics and fantasy points earned. This allows an owner to recognize similar players that may be appropriate for trading, activating, free agent pickup or other transaction. The comparison performed by the Player Compare widget may be based on statistics for that day, season, or career.

On-Screen Alerts

Under “Alerts”, an owner is able to select the type and frequency of on-screen alerts. Once settings are saved, system displays on on-screen alert based on selected alert criteria. The owner can open the alert to learn more information or close the alert. The owner is able to view a log of on-screen alerts received over a specified period (day, week, month).

Alert types include:

Injuries—the owner receives an on-screen alert when a player from their fantasy roster is injured. Once the alert is received, owner can select an option to view the top free agents available in the owner's fantasy league based on fantasy points and position.

Top performers—The owner receives an on-screen alert for players that exceed a specific number of fantasy points (for example, over 30 fantasy points) for a given position in a given day as specified by the owner from the alert setting menu.

Players that show up in alerts can be added to the owner's “watch” list that is displayed in the Player Profile Widget. Other alerts can be added by the owner as desired.

While the foregoing has been with reference to a particular embodiment of the invention, it will be appreciated by those skilled in the art that changes in this embodiment may be made without departing from the principles and spirit of the invention, the scope of which is defined by the appended claims.

We claim:

1. A method for presenting fantasy game information comprising:
selecting a fantasy team in a fantasy league managed on a host site;
scraping data from the host site and transferring it to a fantasy scoring engine;
generating fantasy data at said fantasy scoring engine;
transferring the fantasy data to a presentation widget to be displayed to a fantasy owner.

2. The method of claim 1 wherein the scraping of data from the host site is accomplished using a scraping module.

3. The method of claim 2 wherein the scraping module collects roster data, league rules, and scoring rules from the host site.

4. The method of claim 3 wherein roster data is stored in a database at a system site separate from the host site.

5. The method of claim 4 wherein the fantasy scoring engine provides fantasy data to a fantasy data agent.

6. The method of claim 5 further including a plurality of presentation widgets for display to the fantasy owner.

7. The method of claim 6 wherein the fantasy data agent sends alert messages to the fantasy owner based on the occurrence of an event selected by the user.

8. The method of claim 7 wherein a scoreboard widget displays a scoreboard for a first team in a head-to-head fantasy competition with a second team.

9. The method of claim 8 wherein the scoreboard widget is available for viewing during the competition period of the head-to-head fantasy competition.

10. The method of claim 9 wherein the scoreboard widget displays a scoreboard for other teams in head-to-head competition from the fantasy league.
